(19) United States
(12) Patent Application Publication
(10) Pub. No.: US 2019/0098638 A1
(43) Pub. Date: Mar. 28, 2019

(54) METHOD FOR WIRELESS COMMUNICATION, USER EQUIPMENT, AND BASE STATION

(71) Applicants: DOCOMO INNOVATIONS, INC., Palo alto, CO (US); NTT DOCOMO, INC., Tokyo (JP)

(72) Inventors: Yuichi Kakishima, Tokyo (JP); Satoshi Nagata, Tokyo (JP); Chongning Na, Tokyo (JP)

(73) Assignee: NTT DOCOMO, INC., Tokyo (JP)

(21) Appl. No.: 16/300,416

(22) PCT Filed: May 11, 2017
(86) PCT No.: PCT/US2017/032211

§ 371 Date: Nov. 9, 2018

Related U.S. Application Data
(60) Provisional application No. 62/334,904, filed on May 11, 2016.

(51) Int. Cl. H04W 72/08; H04J 13/16; H04L 5/00

(52) U.S. Cl. CPC H04W 72/082; H04J 13/16; H04W 88/02; H04L 5/0073; H04L 5/0048

(57) ABSTRACT

A method for wireless communication includes receiving, with a user equipment (UE), first information indicating predetermined resources of first resources used for transmission of first signals and second information indicating alignment of interference levels caused by transmission in the predetermined resources, from a first base station (BS), and receiving, with the UE, the first signals using the first information and the second information from the first BS, and second signals transmitted using second resources. The predetermined resources cause interference with the second resources at the UE. Transmission power of signals in the predetermined resources may be identical. Signals sent using the predetermined resources may be precoded with an identical precoder.

### TECHNICAL FIELD

The present invention generally relates to wireless communications and, more particularly, to an interference alignment scheme for beam selection in a wireless communication system.

### BACKGROUND ART

In Long Term Evolution (LTE) Release 13 (Rel. 13 LTE), standardized by the Third Generation Partnership Project (3GPP), a beam selection-based Channel State Information (CSI) feedback scheme was introduced. According to the CSI feedback scheme in Rel. 13 LTE, a base station (BS) transmits multiple beamformed (BF) CST Reference Signals (CSI-RSs) precoded with different precoders. Then, a user equipment (UE) transmits feedback information including an index of a desired beam (CSI-RS) out of the multiple BF CSI-RSs as a CSI-RS resource indicator (CRI). The CRI is also referred to as a beam index (BI). In the above beam selection in Rel. 13 LTE, it is assumed that the UE performs channel estimation using the received CSI-RS. As a result, the UE can efficiently distinguish signals from a serving (desired) cell (desired signals (or own signals)) from signals from an interfering cell (interfering signals).

On the other hand, for a future Multiple Input Multiple Output (MIMO) operation in Rel. 14 LTE and New Radio (NR; fifth generation (5G) radio access technology), it may be required that simplification of a beam selection technology in order to cater for a larger number of beam candidates for massive arrays. One of promising technologies may be receive (Rx) power-based beam selection, which does not require the channel estimation of the received signals or channels, e.g., CSI-RS. In the Rx power-based beam selection, the UE compares Rx power of the multiple downlink signals/channels, e.g., BF CSI-RSs, and simply select the beam based on Rx power, e.g., strongest or weakest Rx power. However, in the Rx power-based beam selection, the UE does not perform the channel estimation and, as a result, the UE may not be able to distinguish desired signals from the interfering signals, i.e., beam selection may be affected by Rx power of interfering signals.

An example operation for the Rx power-based beam selection will be described below with reference to FIGS. 1A and 1B. For simple example, in FIGS. 1A and 1B, a BF CSI-RS A3 from a BS #A may be a desired signal from a serving BS for a UE and a BF CSI-RS B1 from a BS #B may be an interfering signal from an interfering BS for the UE. In the Rx power-based beam selection, as shown in FIG. 1B, it may be required that the UE calculates the Rx power of four resource elements (REs) on which four BS CSI-RSs A1-A4 are multiplexed, and then selects the BF CSI-RS having the maximum Rx power of the calculated Rx power. Multiple CSI-RS resources in the figure can be different antenna ports (APs) for single CSI-RS resource, different CSI-RS resources, etc.

However, according to the Rx power calculation in the Rx power-based beam selection, the UE calculates total power including the Rx power of the desired signals, the interfering signals and noise power caused by thermal noise. That is, the UE may select the beam based on the total power including the Rx power of the interfering signals and the noise power. Turning to FIGS. 1A and 1B, for example, when the BF CSI-RS B1 is the strong interfering signal at the UE, the UE may erroneously select the BF CSI-RS A1 as the desired signal rather than the BF CSI-RS A3. Furthermore, when the REs for the CSI-RSs are precoded with different precoders between the signals from the serving (desired) cell and the interfering cell, the UE may not perform the beam selection properly because the precoder affects reception quality of the received signal.

### CITATION LIST

### Non-Patent Reference

Non-Patent Reference 1: 3GPP, TS 36.211 V 13.1.0
Non-Patent Reference 2: 3GPP, TS 36.213 V 13.1.1

### SUMMARY OF THE INVENTION

According to one or more embodiments of the present invention, a method for wireless communication may comprise receiving, with a user equipment (UE), first information indicating predetermined resources of first resources used for transmission of first signals and second information indicating interference alignment applied to the predetermined resources, from a first base station (BS), and receiving, with the UE, the first signals using the first information and the second information from the first BS, and second signals transmitted using second resources. The predetermined resources may cause interference with the second resources at the UE. An interference level of the predetermined resources may be aligned.

According to one or more embodiments of the present invention, a user equipment (UE) may comprise a receiver that receives, from a base station (BS), first information indicating predetermined resources of first resources used for transmission of first signals and second information indicating interference alignment applied to the predetermined resources, the first signals using the first information and the second information, and second signals transmitted using second resources. The predetermined resources may cause interference with the second resources at the UE. An interference level of the predetermined resources may be aligned.

According to one or more embodiments of the present invention, a base station (BS) may comprise a processor that causes an interference level of predetermined resources of first resources to be aligned, and a transmitter that transmits first information indicating the predetermined resources and second information indicating that the interference level of the predetermined resources is aligned. The transmitter may transmit first signals using the first resources to a user equipment (UE). The predetermined resources may cause interference with second resources used for transmission of second signals at the UE.

According to one or more embodiments of the present invention, proper beam selection can be performed even if the UE receives interfering signals.

### BRIEF DESCRIPTION OF THE DRAWINGS

FIG. 1A is a diagram showing an example of CSI-RSs transmission in a serving sell and an interfering cell.

FIG. 1B is a diagram showing an example of a configuration of resources on which CSI-RSs are multiplexed.

FIG. 2A is a diagram showing a configuration of a wireless communication system and an example of a case where interference alignment applies to interfering resources that causes inter-cell interference according to one or more embodiments of the present invention.

FIG. 2B is a diagram showing an example of a case where interference alignment applies to interfering resources that causes intra-cell interference according to one or more embodiments of the present invention.

FIG. 3A is a flow chart showing a UE procedure according to one or more embodiments of the present invention.

FIG. 3B is a diagram showing an example of interfering resources and interference alignment applied to the interfering resources according to one or more embodiments of the present invention.

FIG. 4 is a sequence diagram showing an example operation for beam selection according to one or more embodiments of a first example of the present invention.

FIG. 5 is a sequence diagram showing an example operation for beam selection according to one or more embodiments of a second example of the present invention.

FIG. 6 is a sequence diagram showing an example operation for beam selection according to one or more embodiments of a third example of the present invention.

FIG. 7 is a sequence diagram showing an example operation for beam selection according to one or more embodiments of a fourth example of the present invention.

FIG. 8 is a sequence diagram showing an example operation for beam selection according to one or more embodiments of a fifth example of the present invention.

FIG. 9A is a diagram showing a resource element configuration of a serving (desired) cell and an interfering cell according to a conventional method.

FIG. 9B is a diagram showing a resource element configuration of a serving (desired) cell and an interfering cell according to one or more embodiments of a sixth example of the present invention.

FIG. 10A is a diagram showing a resource element configuration of a serving (desired) cell and an interfering cell according to a conventional method.

FIG. 10B is a diagram showing a resource element configuration of a serving (desired) cell and an interfering cell according to one or more embodiments of a seventh example of the present invention.

FIG. 11 is a sequence diagram showing an example operation for beam selection according to one or more embodiments of another example of the present invention.

FIG. 12A is a diagram showing resource elements to which a predetermined interference alignment is applied according to one or more embodiments of another example of the first to seventh examples of the present invention.

FIG. 12B is a diagram showing resource elements to which a predetermined interference alignment is applied according to one or more embodiments of another example of the first to seventh examples of the present invention.

FIG. 12C is a diagram showing resource elements to which a predetermined interference alignment is applied according to one or more embodiments of another example of the first to seventh examples of the present invention.

FIG. 12D is a diagram showing resource elements to which a predetermined interference alignment is applied according to one or more embodiments of another example of the first to seventh examples of the present invention.

FIG. 13 is a diagram showing the RSs multiplexed on the different time resources and frequency resources precoded with the identical precoder according to one or more embodiments of a first modified example of the present invention.

FIG. 14 is a diagram showing the RSs multiplexed on the different time resources and frequency resources precoded with the identical precoder according to one or more embodiments of a second modified example of the present invention.

FIG. 15 is a block diagram showing a schematic configuration of a base station according to one or more embodiments of the present invention.

FIG. 16 is a block diagram showing a schematic configuration of a user equipment according to one or more embodiments of the present invention.

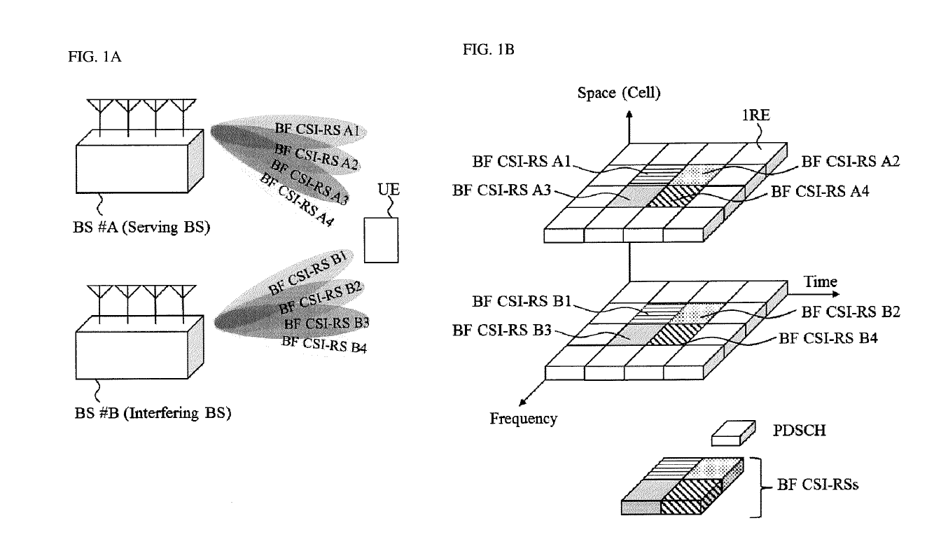

### DETAILED DESCRIPTION OF EMBODIMENTS

Embodiments of the present invention will be described in detail below, with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

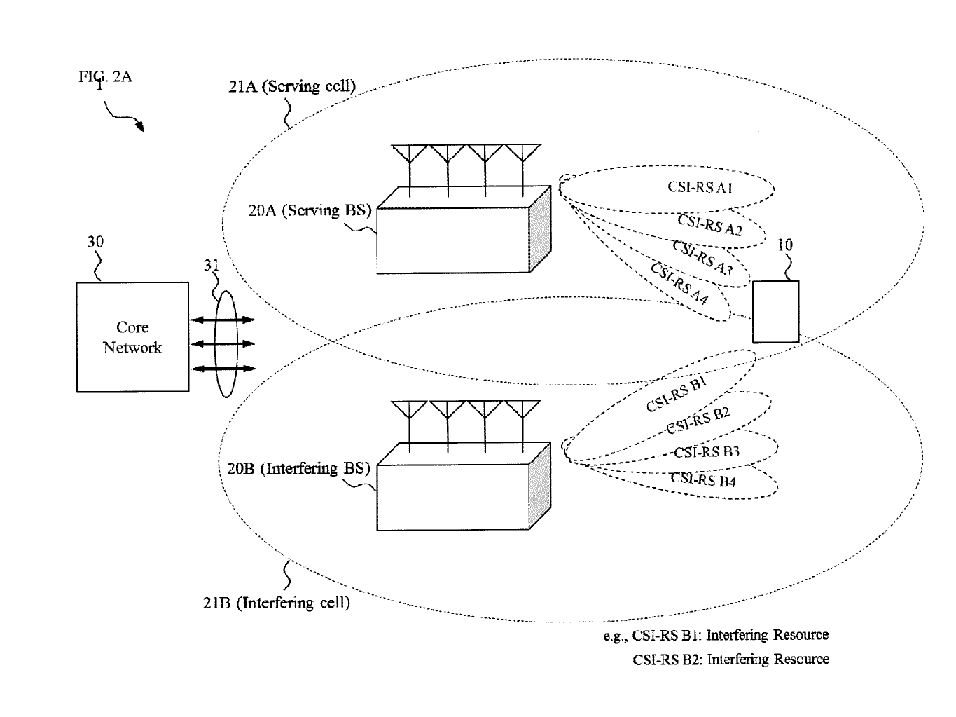

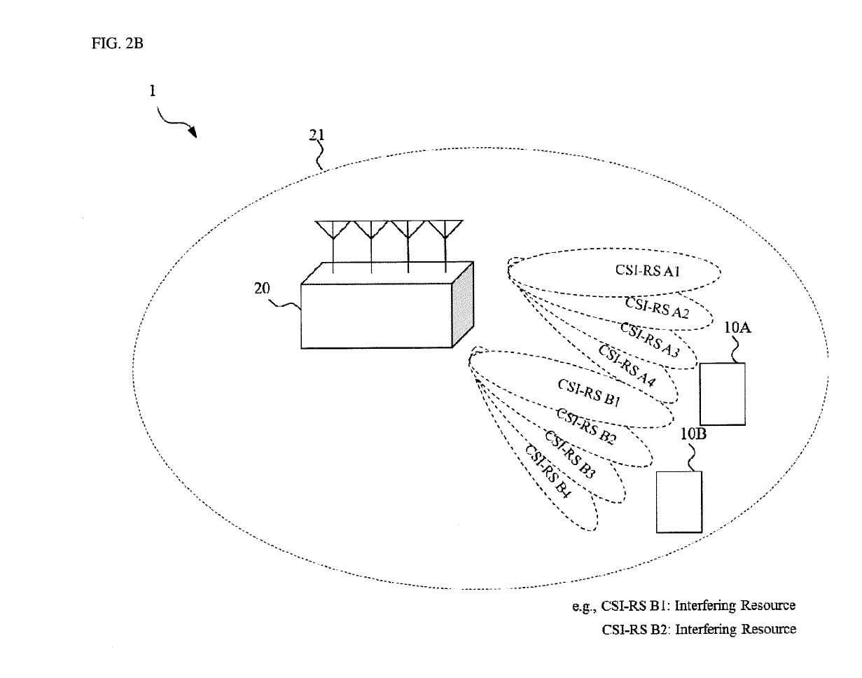

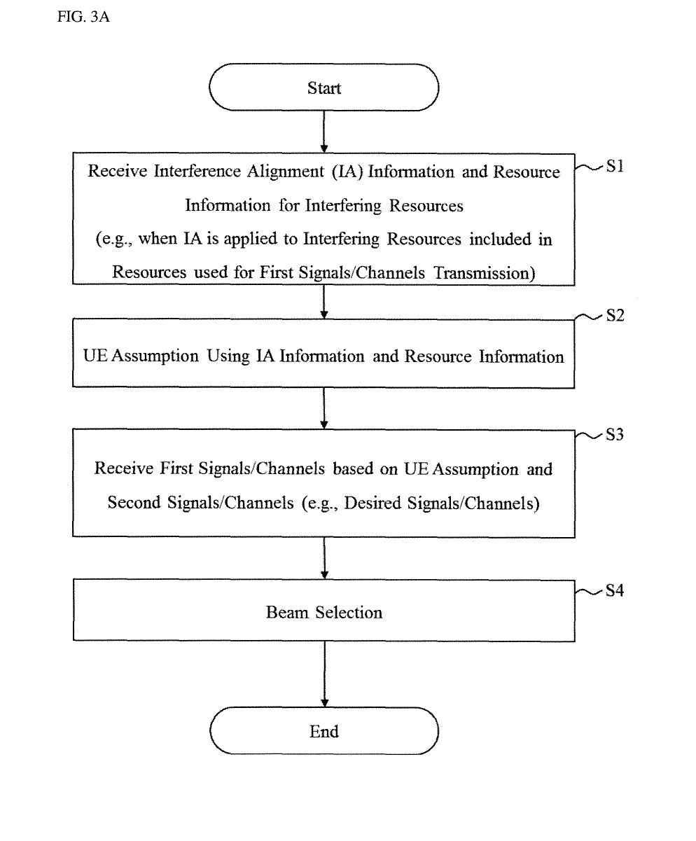

FIG. 2A illustrates a wireless communications system 1 according to one or more embodiments of the present invention. The wireless communication system 1 includes a user equipment (UE) 10, base stations (BSs) 20 (20A and 20B), and a core network 30. The wireless communication system 1 may be a New Radio (NR) system, an LTE/LTE-Advanced (LTE-A) system, or other systems. The wireless communication system 1 is not limited to the specific configurations described herein and may be any type of wireless communication system. The BSs 20B and 20A are an example of a first base station and a second base station, respectively.

The BS 20 may communicate uplink (UL) and downlink (DL) signals with the UE(s) 10 in a cell 21 via multiple antenna ports using MIMO technology. The DL and UL signals may include control information and user data. The BS 20 may communicate DL and UL signals with the core network 30 through backhaul links 31. The BS 20 may be a gNodeB (gNB) or an. Evolved NodeB (eNB). The BS 20 may transmit one set of Channel State Information Reference Signal(s) (CSI-RS(s)). For example, the BS 20A may transmit CSI-RSs A1-A4 and the BS 20B may transmit CSI-RSs B1-B4. For example, the CSI-RSs may or may not be beamformed.

The BS 20 includes one or more antennas, a communication interface to communicate with an adjacent BS 20 (for example, X2 interface), a communication interface to communicate with the core network 30 (for example, S1 interface), and a CPU (Central Processing Unit) such as a processor or a circuit to process transmitted and received signals with the UE 10. Operations of the BS 20 may be implemented by the processor processing or executing data and programs stored in a memory. However, the BS 20 is not limited to the hardware configuration set forth above and may be realized by other appropriate hardware configurations as understood by those of ordinary skill in the art. Numerous BSs 20 may be disposed so as to cover a broader service area of the wireless communication system 1.

The UE 10 may communicate DL and UL signals that include control information and user data with the BS 20 using MIMO technology. The UE 10 may be a mobile station, a smartphone, a cellular phone, a tablet, a mobile router, or information processing apparatus having a radio communication function such as a wearable device. The wireless communication system 1 may include one or more UEs 10. The UE 10 may receive at least multiple CSI-RSs from the BS 20.

The UE 10 includes a CPU such as a processor, a RAM (Random Access Memory), a flash memory, and a radio communication device to transmit/receive radio signals to/from the BS 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

As shown in FIG. 2A, one or more embodiments of the present invention may apply to interfering resources that causes inter-cell interference. For example, the BS 20A (cell 21A) may be a serving BS (serving (desired) cell) for the UE 10 and the BS 20B (21B) may be an interfering BS (interfering cell) for the UE 10. Furthermore, signals from the serving BS 20A (cell 21A) may be desired signals for the UE 10 and signals from the interfering BS 20B (cell 21B) may be interfering signals for the UE 10. As shown in FIG. 2A, for example, when the CSI-RSs A1-A4 are desired signals for the UE 10, resources used for transmission of the CSI-RSs B1 and B2 may be interfering resources that cause interference with resources used for transmission of the CSI RSs A1 and A2.

On the other hand, as shown in FIG. 2B, one or more embodiments of the present invention may apply to interfering resources that causes intra-cell interference with other resources in the same cell. For example, in an example of FIG. 2B, when the CSI-RSs A1-A4 are desired signals for the UE 10A, resources used for the CSI-RSs B1 and B2 transmitted to the UE 10B may be interfering resources that cause interference with resources used for the CSI-RSs A1 and A2 transmitted to the UE 10A.

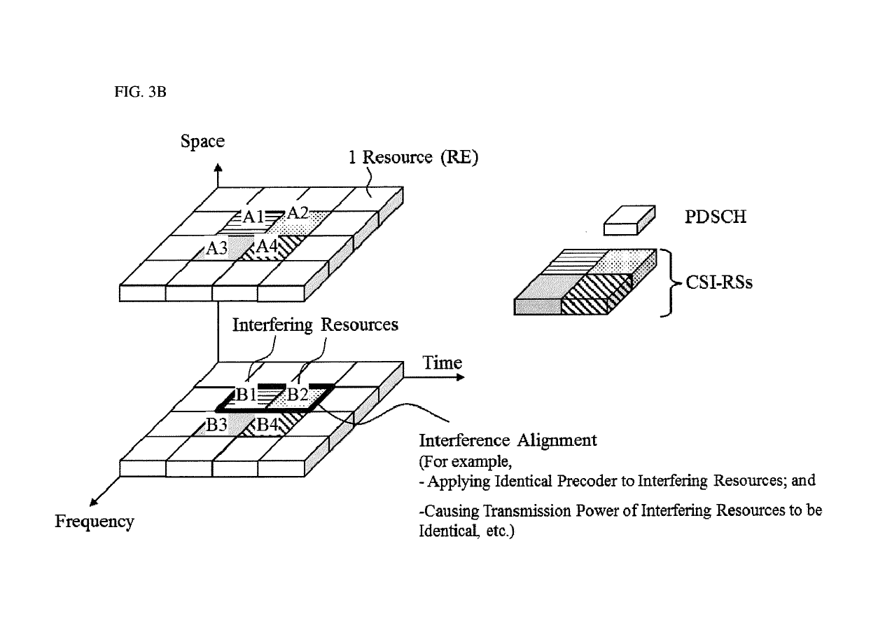

FIG. 3 is a diagram showing a flow chart of a UE procedure according to one or more embodiments of the present invention. In an example of FIG. 3A, interference alignment (IA) is applied to interfering resources included in resources used for first signals/channels transmission. The BS 20 may perform the IA of the interfering resources. In one or more embodiments of the present invention, the IA may be a method for aligning interference levels so that reception quality (signal strength) of the interfering signals in different resources becomes the same level. For example, the interfering resources used for the first signals/channels transmission may cause interference with resources used for second signals/channels transmission. In one or more embodiments of the present invention, the first signals/channels and the second signals/channels may be transmitted from the same BS 20 or different BSs 20 (BS 20A and 20B).

As shown in FIG. 3A, at step S1, the UE 10 may receive interference alignment (IA) information (e.g., transmission power, precoder, code division multiplexing (CDM), and scrambling applied to the resources) and resource information for interfering resources from the BS 20. The IA information may be precoding information and/or transmission power information. For example, the precoding information may indicate a precoder (precoding vector) applied to the interfering resources as the IA. For example, the transmission power information may indicate a transmission power value used for the interfering resources (signals/channels). For example, transmission power can be informed as relative value to certain default value. For example, the resource information may indicate the interfering resources to which the IA is applied. For example, this information can be informed implicitly.

At step S2, the UE 10 may perform a UE assumption using the received IA information and the resource information. For example, the UE 10 may assume a precoder applied to the interfering resources in the first signal/channels. For example, the UE 10 may assume the transmission power of the interfering resources in the first signals/channels. For example, the UE may assume a location of the interfering resources to which the IA is applied. For example, this resource information can include a time/frequency resource within a slot (or subframe) periodicity and time domain offset. For example, this resource information can include resource block (RB) information.

At step S3, the UE 10 may receive the first signals/channels based on the UE assumption and receive the second signals/channels from the BS(s) 20.

At step S4, the UE 10 may perform the beam selection based on the received first signals/channels.

Thus, according to one or more embodiments of the present invention, even if the UE 10 receives the interfering signals, the proper beam selection can be performed because CSI-RS resources are suffered by same level of interference by applying the IA to the resources for the RSs.

In one or more embodiments of the present invention, the first signals/channels (interfering signals) and the second signals/channels (desired signals) may be the CSI-RS, Zero Power (ZP) CSI-RS, sounding RS (SRS), demodulation reference signal (DM-RS), physical downlink shared channel (PDSCH) and physical uplink shared channel (PUSCH).

In one or more embodiments of the present invention, an example of the interfering resources and the IA that applies to the interfering resources will be described below with reference to FIG. 3B. In FIG. 3B, each resource is one resource element (RE). In an example of FIG. 3B, resources used for transmission of the CSI-RSs B1 and B2 may be interfering resources (interfering resources B1 and B2). For example, the interfering resources B1 and B2 may cause interference with resources used for transmission of the CSI-RSs A1 and A2 (resources A1 and A2), respectively. In one or more embodiments of the present invention, when a resource (e.g., interfering resource B1 (B2)) causes interference with another resources (e.g., resource A1 (A2)), the interfering resource B1 (B2) may be in collision with the resource A1 (A2) in frequency and time resources.

As shown in FIG. 3B, in the BS 20, the IA may be applied to the interfering resources B1 and B2. For example, an identical precoder may be applied to the interfering resources B1 and B2. For example, in the BS 20, transmission power of the interfering resources B1 and B2 may be caused to be identical. First to seventh examples of the IA will be described below in detail.

In one or more embodiments of the first to seventh examples of the present invention, the present disclosure will describe examples of the IA applied to the inter-cell interference, but one or more embodiments of the present invention may also apply to the IA applied to the intra-call interference.

In one or more embodiments of the present invention, the interfering resources may be resources that cause interference with all or part of resources used for the beam selection.

### First Example

According to one or more embodiments of a first example of the present invention, the interfering resources (REs) may be precoded with an identical precoder. For example, at least two resources of resources used for the CSI-RS transmission may be precoded with the identical precoder.

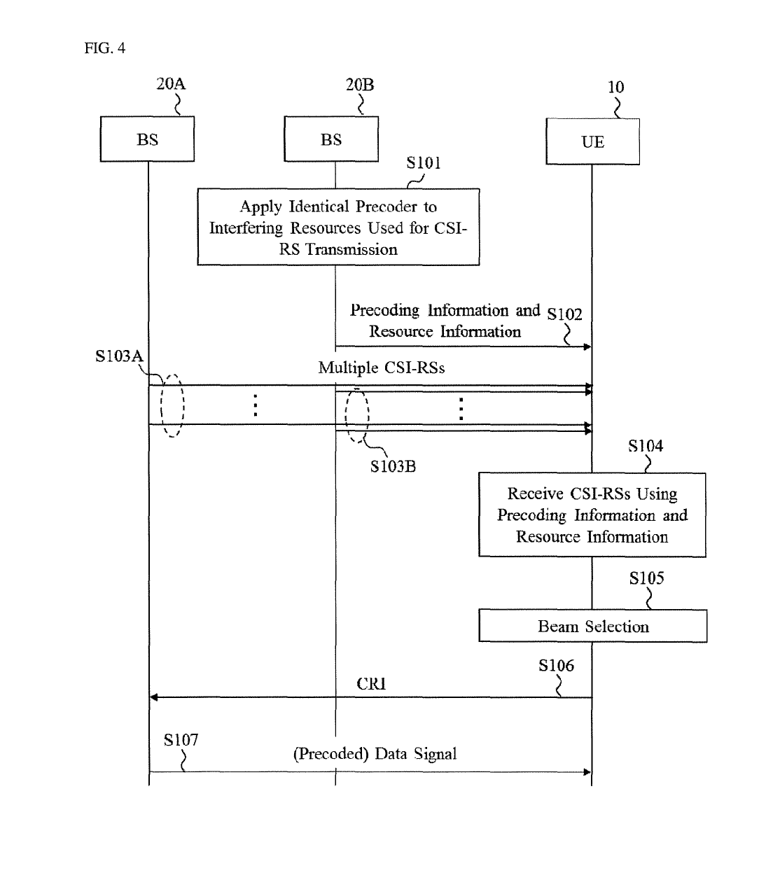

FIG. 4 is a sequence diagram showing an example operation for the beam selection according to one or more embodiments of the first example of the present invention. For example, the BS 20A may be the serving BS for the UE 10 and the BS 20B may be the interfering BS for the UE 10. As shown in FIG. 4, the BS 20B may apply the identical precoder to the interfering resources of resources that multiplexes the CSI-RSs (steps S101). Thus, the precoders used for interfering resources that multiplexes the CSI-RS are identical. Furthermore, for example, before the step S101, information indicating the interfering resource may be exchanged between the BSs 20A and 20B via the X2 interface or transmitted from the UE 10 to the BS 20B.

The BS 20B may transmit precoding information and resource information to the UE 10 (step S102). The precoding information may indicate the precoder (precoding vector) applied to the interfering resources. The resource information may indicate a location of the interfering resources precoded with the identical precoder.

The BS 20A may transmit the multiple CSI-RSs (desired signals) using resources to the cell 21A using beams (step S103A). The BS 20B may transmit the multiple CSI-RSs using resources including the interfering resources precoded with the identical precoder to the cell 21B using beams (step S103B).

The UE 10 may receive the CSI-RSs using the precoding information and the resource information from the BS 20B and the CSI-RSs from the BS 20A (step S104). The reception quality of the CSI-RSs from the BS 10B (interfering signals) may be the same level because the interfering resources are precoded with the identical precoder. The reception quality may be a Reference Signal Received Power (RSRP), Received Signal Strength Indicator (RSSI) or other information that reflects channel quality.

Then, the UE 10 may perform the beam selection based on the received CSI-RSs (step S105). For example, the UE 10 may select a CSI-RS resource indicator (CRI) out of the received CSI-RSs implicitly based on the reception quality of the CSI-RSs from the BS 20A (without being affected by the interfering signals from the BS 20B).

The UE 10 may transmit the selected CRI as feedback information to the BS 20A (step S106). The UE 10 may feedback some other CSI such as Precoding Type Indicator (PTI), a Rank Indicator (RI), a Precoding Matrix Indicator (PMI), and a Channel Quality Information (CQI). The CRIs may be transmitted via a Physical Uplink Control Channel (PUCCH) or other physical channels.

The BS 20A may transmit, to the UE 10, precoded data signals via a Physical Downlink Shared Channel (PDSCH) using a beam determined based on the CRI (step S107).

Thus, according to one or more embodiments of the present invention, the UE 10 may receive from the BS 10, the resource information (first information) indicating a location of the interfering resources (predetermined resources) of resources (first resources) used for transmission of the CSI-RSs (first signals) and the precoding information (second information) indicating the identical precoder (interference alignment applied to the predetermined resources). The UE 10 may the CSI-RSs including the interfering resources (first signals) using the resource information and the precoding information, and the (desired) CSI-RSs (second signals) transmitted using resources (second resources). The interfering resources may cause interference with the resources of the desired CSI-RSs (second resources) at the UE 10. An interference level of the interfering resources may be aligned. For example, the interfering resources may be precoded with the identical precoder.

According to one or more embodiments of the first example of the present invention, the interference level (the signal strength such as power) of the interfering signals may be aligned in the interfering cell by applying the identical precoder to the interfering resources that cause interference with resources used for transmission of the desired signal. As a result, it may be possible to decrease errors of the beam selection even if the UE 10 receives the interfering signals.

Furthermore, in one or more embodiments of the first example of the present invention, for example, the identical precoder applied to the interfering resources may be a predetermined precoder.

Furthermore, in one or more embodiments of the first example of the present invention, for example, at the step S102, the identical precoder in the precoding information may be notified as the PMI or the CRI to the UE 10.

Furthermore, in one or more embodiments of the first example of the present invention, for example, the UE 10 may transmit, to the BS 20, information indicating the identical precoder applied to the interfering resources. The identical precoder may be notified as the PMI or the CRI to the BS 20.

### Second Example

According to one or more embodiments of a second example of the present invention, precoding for the REs used for the beam selection may be disabled at the interfering BS 20B.

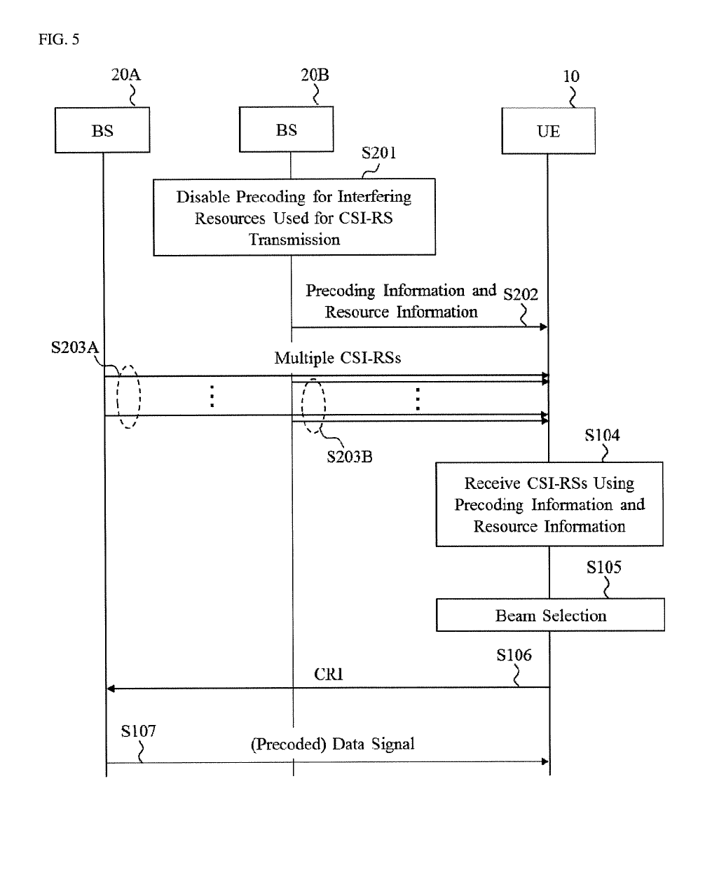

FIG. 5 is a sequence diagram showing an example operation for the beam selection according to one or more embodiments of the second example of the present invention. Similar steps in FIG. 5 to steps in FIG. 4 may have the same reference label.

As shown in FIG. 5, the BS 20B may disable precoding for the interfering resources used for the multiple CSI-RS transmission (step S201).

The BS 20B may transmit precoding information and resource information to the UE 10 (step S202). The precoding information may indicate whether the precoding is disabled or not. The resource information may indicate a location of the interfering resources.

The BS 20A may transmit the multiple CSI-RSs (desired signals) using resources to the cell 21A using beams (step S203A). The BS 20B may transmit the multiple CSI-RSs (interfering signals) using resources including the interfering resources for which the precoding is disabled to the cell 21B using beams (step S203B). Steps after the next step of the step S203B in FIG. 5 are the same as the steps in FIG. 4.

According to one or more embodiments of the second example of the present invention, the interference level (signal strength such as power) of the interfering signals may be aligned in the interfering cell. As a result, it may be possible to decrease errors of the beam selection even if the UE 10 receives the interfering signals.

### Third Example

According to one or more embodiments of a third example of the present invention, the interfering resources may be precoded with a precoder for which gain is small enough not to affect relative level of interfering signal. For example, the interfering resources may be precoded with a precoder for which gain is less than a predetermined value. For example, wide beam is derived based on the PMI(s), which is fed back wideband and/or long-term, i.e., a subset of the indexes of the PMIs.

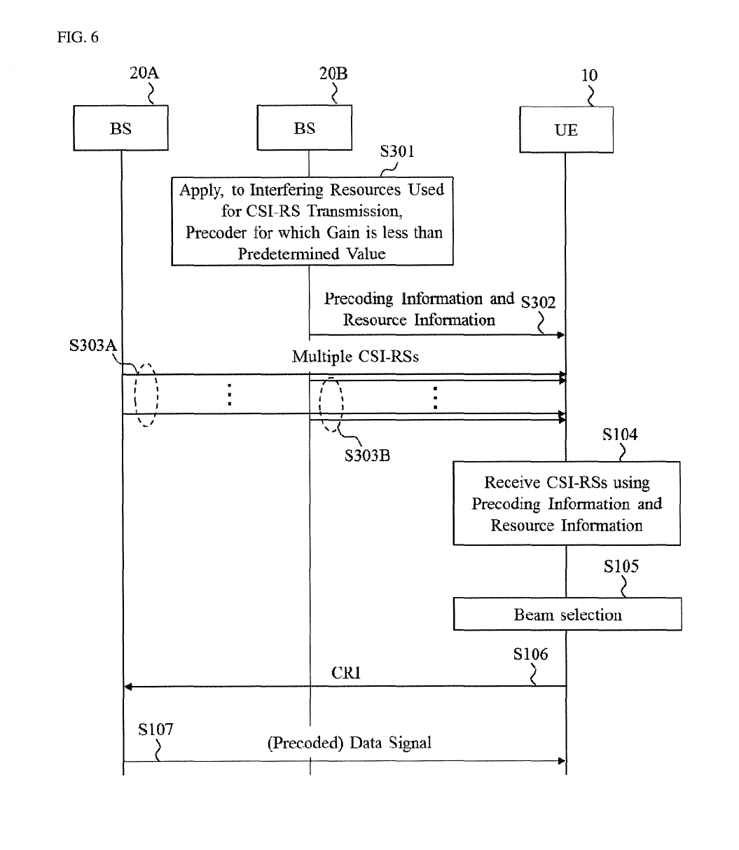

FIG. 6 is a sequence diagram showing an example operation for the beam selection according to one or more embodiments of the third example of the present invention. Similar steps in FIG. 6 to steps in FIG. 4 may have the same reference label.

As shown in FIG. 6, the BS 20B may apply the precoder for which gain is less than a predetermined value to the interfering resources (steps S301).

The BS 20B may transmit precoding information and resource information to the UE 10 (step S302). The precoding information may indicate the precoder (precoding vector) applied to the interfering resources. The resource information may indicate a location of the interfering resources.

The BS 20A may transmit the multiple CSI-RSs (desired signals) using resources to the cell 21A using beams (step S303A). The BS 20B may transmit the multiple CSI-RSs (interfering signals) using resources including the interfering resources precoded with the precoder for which gain is less than a predetermined value to the cell 21B using beams (step S303B). For example, the predetermined value may be gain of the inferring signals that does not affect the UE 10. Steps after the next step of the step S303B in FIG. 6 are the same as the steps in FIG. 4.

According to one or more embodiments of the third example of the present invention, it is possible to decrease fluctuations of the power of the interfering signals. As a result, it may be possible to decrease errors of the beam selection even if the UE 10 receives the interfering signals.

### Fourth Example

According to one or more embodiments of a fourth example of the present invention, the transmission power of the interfering resources used of the CSI-RS transmission may be caused to be identical. For example, the interfering resources may be muted.

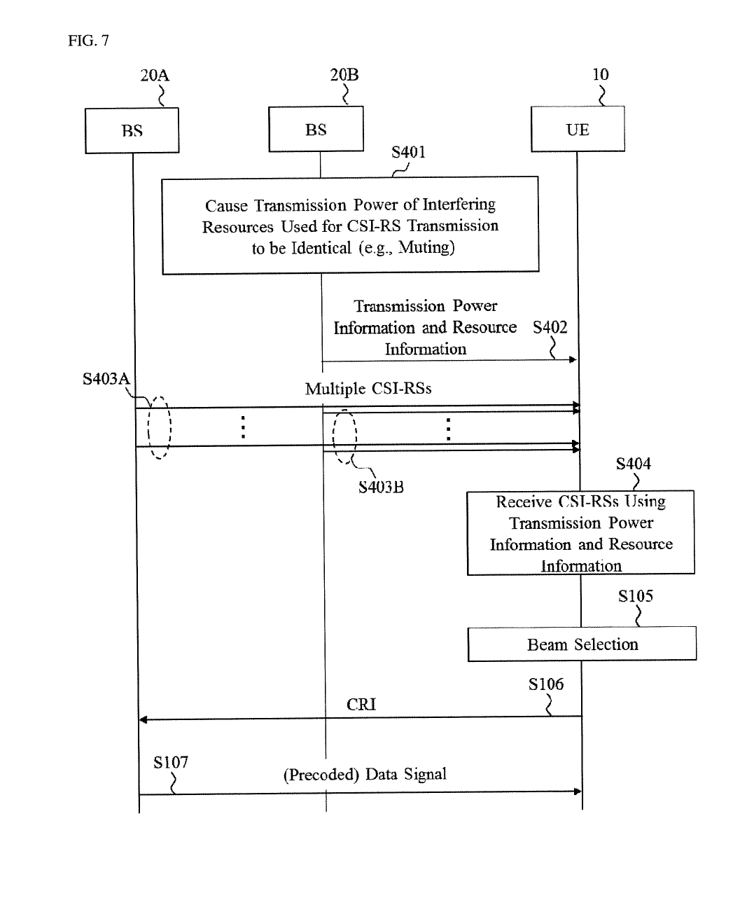

FIG. 7 is a sequence diagram showing an example operation for the beam selection according to one or more embodiments of the fourth example of the present invention. Similar steps in FIG. 7 to steps in FIG. 4 may have the same reference label.

As shown in FIG. 7, the BS 20B may cause the transmission power of the interfering resources to be identical. For example, the interfering resources may be muted (step S401).

The BS 20B may transmit transmission power information (second information) and resource information (first information) to the UE 10 (step S402). The transmission power information may indicate the transmission power value applied to the interfering resources. For example, the transmission power information may indicate that the interfering signals are muted. The resource information may indicate a location of the interfering resources.

The BS 20A may transmit the multiple CSI-RSs (desired signals) using resources to the cell 21A using beams (step S403A). The BS 20B may transmit the CSI-RSs using resources including the interfering resources that are muted to the cell 21B using beams (step S403B).

The UE 10 may receive the CSI-RSs using the transmission information and the resource information from the BS 20B and the CSI-RSs from the BS 20A (step S404).

Steps after the next step of the step S404 in FIG. 7 are the same as the steps in FIG. 4.

According to one or more embodiments of the third example of the present invention, it is possible to decrease influence of interference. As a result, it may be possible to decrease errors of the beam selection even if the UE 10 receives the interfering signals.

### Fifth Example

According to one or more embodiments of a fifth example of the present invention, transmission power of the interfering resources may be changed by the transmission power of other resources used for the CSI-RS transmission. For example, the transmission power of the interfering resources may be lower than the transmission power of other resources in a subframe including the CSI-RS resources.

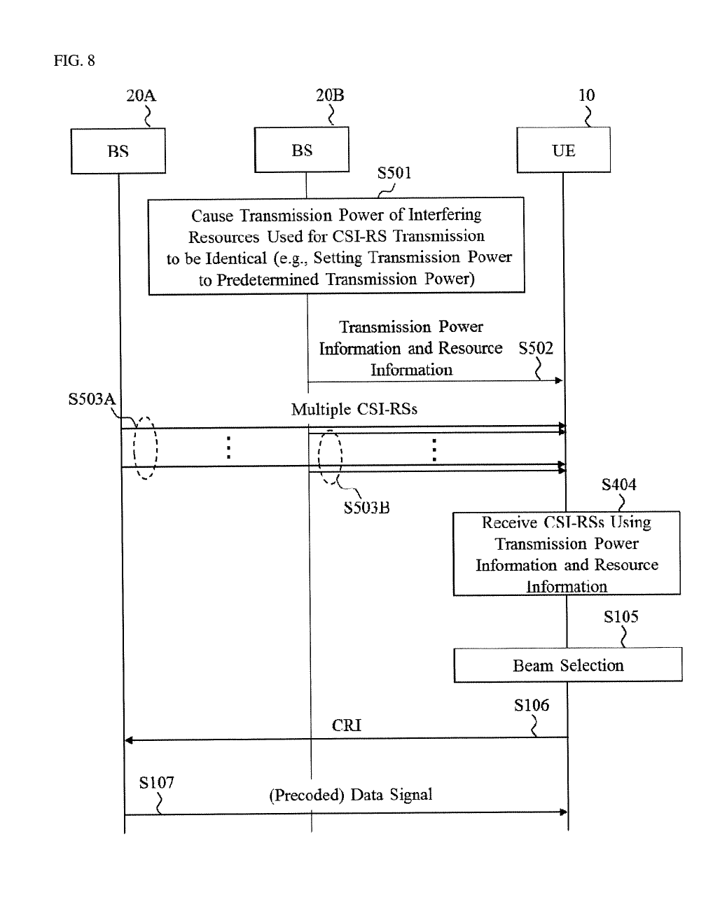

FIG. 8 is a sequence diagram showing an example operation for the beam selection according to one or more embodiments of the fifth example of the present invention. Similar steps in FIG. 8 to steps in FIG. 4 may have the same reference label.

As shown in FIG. 8, the multiple CSI-RSs may be precoded at the BS 20B (step S501). Then, the interfering BS 20B may set the transmission power of the interfering resources so that the transmission power of the interfering resources is lower than the transmission power of other resources in a subframe including the CSI-RS resources.

The BS 20B may transmit transmission power information and resource information to the UE 10 (step S502). The transmission power information may indicate the transmission power value applied to the interfering resources. The resource information may indicate a location of the interfering resources.

The BSs 20A may transmit the multiple precoded CSI-RSs and the BS 20B may transmit the multiple CSI-RSs with lower transmission power (steps S503A and S503B).

Step S404 after the step S503B in FIG. 8 is the same as the steps in FIG. 7. Steps after the next step of the step S404 in FIG. 8 are the same as the steps in FIG. 4.

According to one or more embodiments of the fifth example of the present invention, it is possible to decrease influence of interference. As a result, it may be possible to decrease errors of the beam selection even if the UE 10 receives the interfering signals.

As another example of the fifth example, the transmission power of the interfering resources may be constant. As a result, it is possible to align influence of the interference by setting the transmission power of the interfering resources to be constant.

Furthermore, in one or more embodiments of the fifth example of the present invention, for example, the BS 20 may notify the UE 10 of information indicating the CSI-RSs are transmitted with the certain transmission power.

Furthermore, in one or more embodiments of the fifth example of the present invention, for example, the BS 20 may notify the UE 10 of transmission power information indicating an absolute value of the transmission power and a relative value to some other signals/channels.

### Sixth Example

According to one or more embodiments of a sixth example of the present invention, at the interfering cell, CDM is applied to the interfering resources. For example, different beams used for the CSI-RS transmission may be spread and arranged in a plurality of resources by applying CDM to the beams.

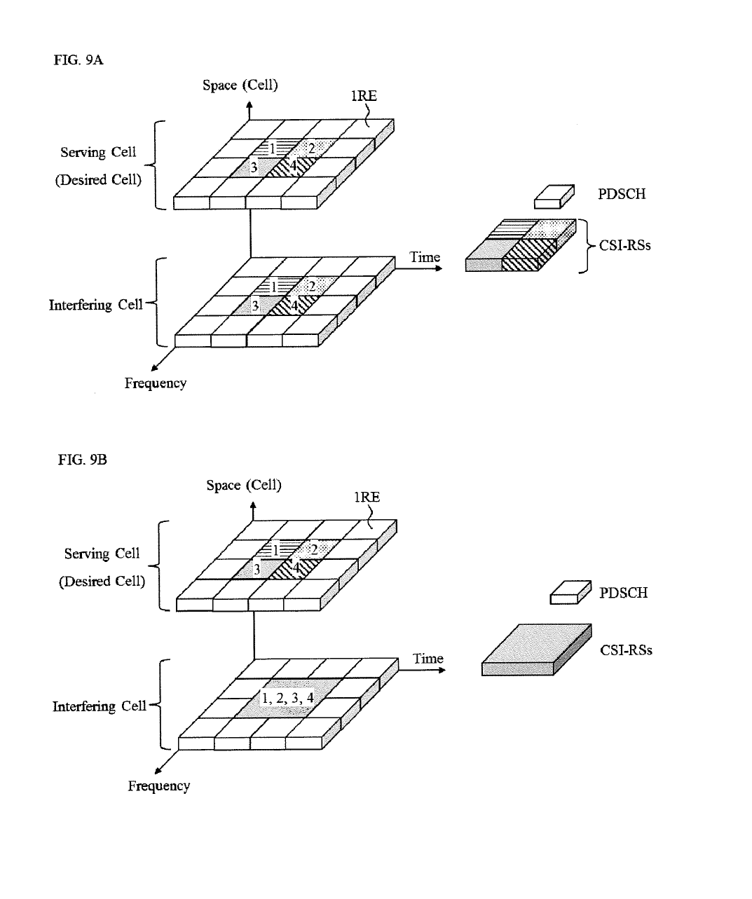

FIG. 9A is a diagram showing a RE (resource) configuration of the serving (desired) cell and the interfering cell according to a conventional method. As shown in FIG. 9A, for example, each of four CSI-RSs (e.g., CSI-RSs #1-4) is multiplexed on each RE in the serving cell and the interfering cell.

FIG. 9B is a diagram showing a RE configuration of the serving (desired) cell 21A and the interfering cell 21B according to one or more embodiments of a sixth example of the present invention. In one or more embodiments of the sixth example of the present invention, four CSI-RSs from the BS 20B (e.g., CSI-RSs B1-4) may be code division multiplexed on a plurality of REs in the interfering cell. In an example of FIG. 9B, the interfering resources may be resources used for the CSI-RSs B1-4 (resources B1-B4). As shown in FIG. 9B, for example, the resources B1-B4 may be spread and arranged in four REs in the interfering cell.

Thus, the BS 20B may map the CSI-RSs B1-4 to four REs so that the CSI-RS resources that are the interfering resources are spread and arranged in four REs. Then, the BS 20B may transmit the CSI-RSs that are code division multiplexed.

Furthermore, in one or more embodiments of the sixth example of the present invention, for example, the BS 20 may notify the UE 10 of information indicating the CDM applied to the interfering resources.

### Seventh Example

According to one or more embodiments of a seventh example of the present invention, the interfering resources may be scrambled in a set of the CSI-RS resources.

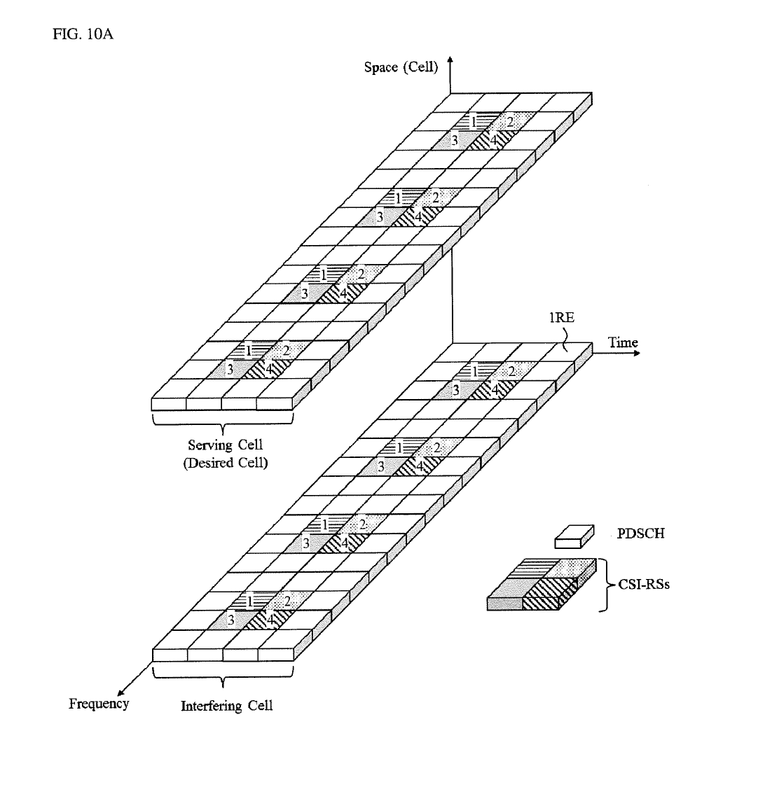

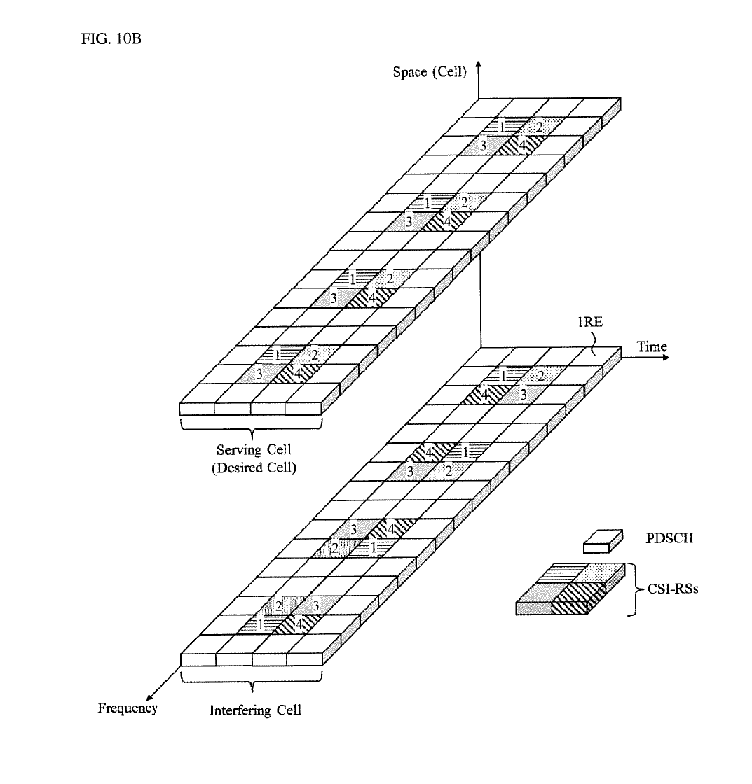

FIG. 10A is a diagram showing a RE configuration of the serving (desired) cell and the interfering cell according to a conventional method. The REs in FIG. 10A are frequency multiplexed REs in FIG. 9A. For example, four sets of the CSI-RS resources for the CSI-RSs #1-4 may be frequency multiplexed. Each set of the CSI-RS resources for CSI-RSs #1-4 has the same arrangement of the CSI-RS resources.

FIG. 10B is a diagram showing a RE configuration of the serving (desired) cell 21A and the interfering cell 21B according to one or more embodiments of the seventh example of the present invention. In an example of FIG. 10B, the interfering resources may be resources used for the CSI-RSs 1-4 (resources 1-4) in the interfering cell 21B. As shown in FIG. 10B, like FIG. 10A, four sets of the CSI-RS resources for the CSI-RSs #1-4 may be frequency multiplexed. Each set of the CSI-RS resources in the serving (desired) cell has the same arrangement of the CSI-RS resources. On the other hand, each set of the CSI-RS resources in the interfering cell has scrambling sequence of the CSI-RS resources. That is, in the interfering cell, the CSI-RS resources for the CSI-RSs #1-4 in each of the four sets of the CSI-RS resources may be scrambled.

Thus, when a plurality of sets of the CSI-RS resources for the CSI-RSs B1-4 are frequency-multiplexed, the BS 20B may map the CSI-RSs B1-4 to the REs so that the CSI-RS resources are scrambled and arranged in each set of the CSI-RS resources. Then, the BSs 20B may transmit the CSI-RSs with the scrambled CSI-RS resources.

Furthermore, in one or more embodiments of the seventh example of the present invention, for example, the BS 20 may notify the UE 10 of scrambling information indicating of the applied scrambling such as scrambling sequence.

### Another Example of the First to Seventh Examples

For proper beam selection, the identical transmission power and/or precoder may be required to be applied to the REs used for the beam selection. As another example, time resources (time domain) of the REs to which the identical transmission power and/or precoder is applied to may be restricted. For example, the identical transmission power and/or precoder may be applied to the REs in a predetermined time resources. As another example, frequency resources (frequency domain) of the REs to which the identical transmission power and/or precoder is applied to may be restricted. For example, the identical transmission power and/or precoder may be applied to the REs in a predetermined frequency resources.

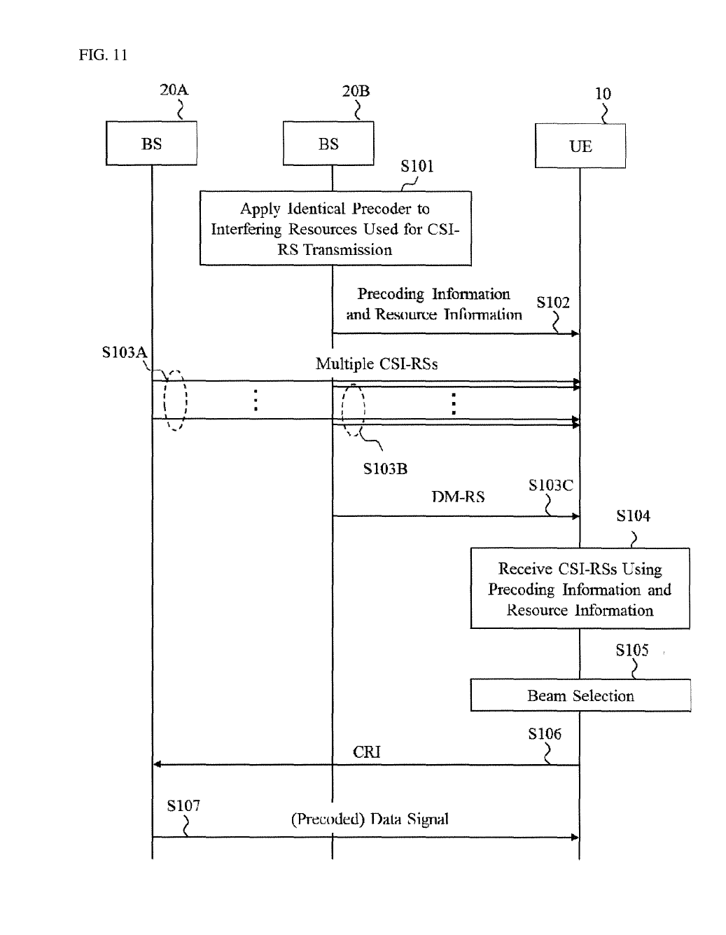

For example, as in one or more embodiments of the first to seventh examples of the present invention, when the transmission power and/or precoder of the REs used for the beam selection is different from the transmission power and/or precoder of the other REs, the REs used for the beam selection may not be able to be decoded. According to one or more embodiments of another example of the present invention, as shown in FIG. 11, the BS 20B may transmit a (specific) DM-RS used for decoding of the REs used for the beam selection (step S103C). Furthermore, transmission of the DM-RS used for decoding of the REs used for the beam selection may apply to operations according to one or more embodiments of the first to seventh examples of the present invention.

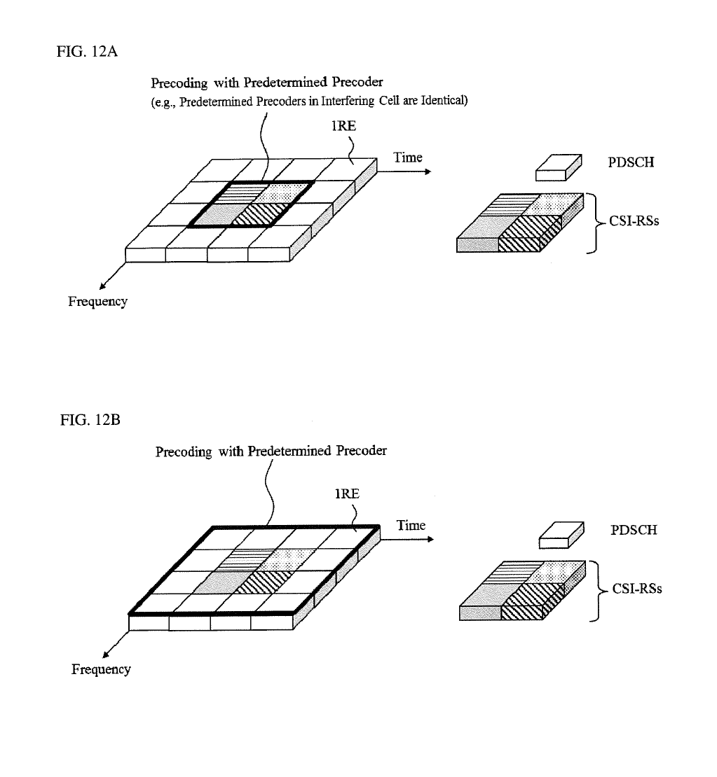

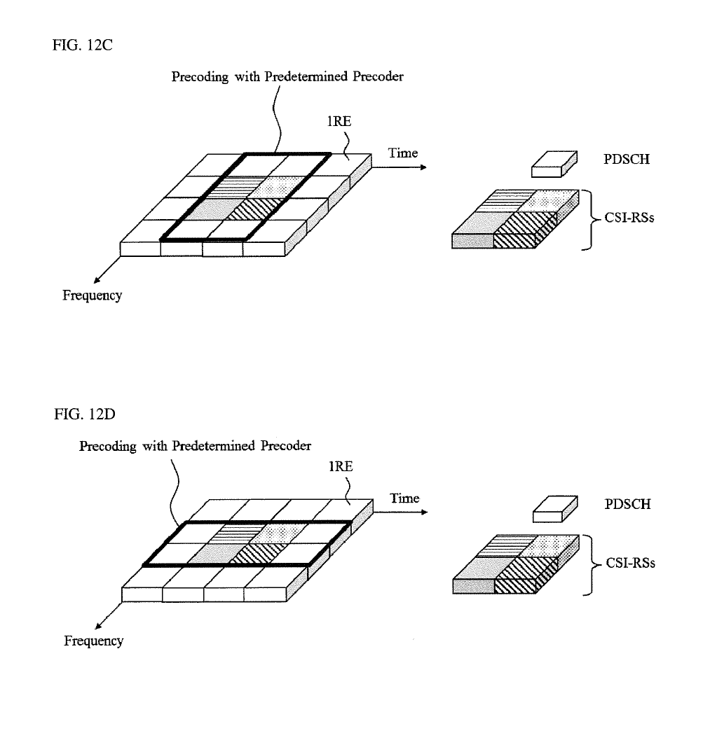

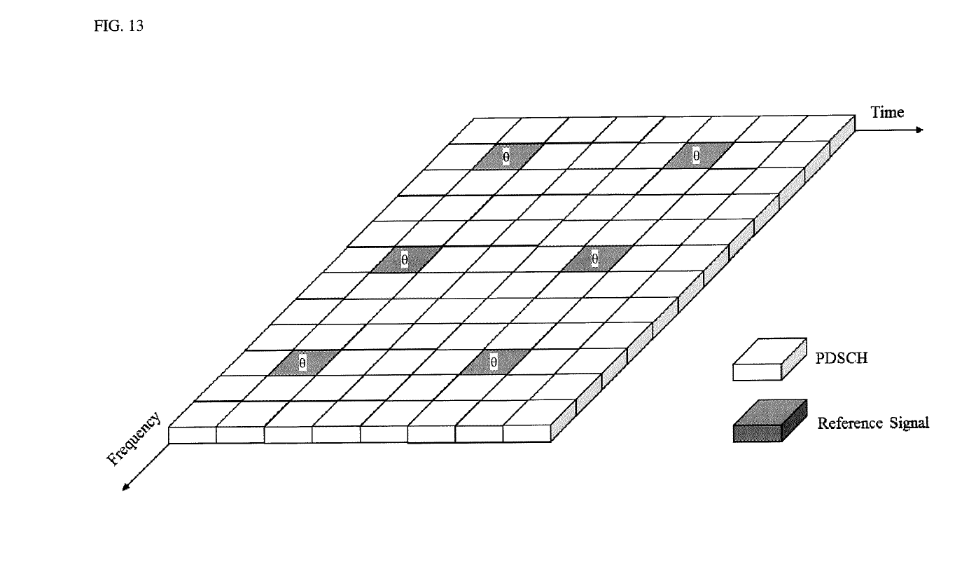

As another example of the first to seventh examples, in the interfering cell, the IA methods of the first to seventh examples may be applied to only the interfering resources or the resources including the resources used for the beam selection. FIGS. 12A-12D are diagrams showing REs to which a predetermined interference alignment is applied according to one or more embodiments of another example of the first to seventh examples of the present invention.

As shown in FIG. 12A, only the interfering resources may be precoded with the predetermined precoder. For example, the predetermined precoders applied to the interfering resources are identical like embodiments of the first example.

As shown in FIG. 12B, REs of predetermined time ranges and frequency ranges including the CSI-RS resources including the interfering resources may be precoded with the predetermined precoder.

As shown in FIG. 12C, for example, REs of predetermined time ranges or symbols (e.g., Orthogonal Frequency-Division Multiplexing (OFDM) symbols) including the CSI-RS resources may be precoded with the predetermined precoder at the interfering BS 20B. Furthermore, for example, an entire subframe including the CSI-RS resources may be precoded with the predetermined precoder. Furthermore, for example, all or part of a plurality of subframes including the CSI-RS resources may be precoded with the predetermined precoder.

As shown in FIG. 12D, for example, at the interfering BS 20B, REs of predetermined frequency ranges (in a frequency domain (resource)) or subcarriers including the CSI-RS resources may be precoded with the predetermined precoder. Furthermore, for example, a resource block (RB) including the CSI-RS resources may be precoded with the predetermined precoder. Furthermore, for example, at least a sub-band including the CSI-RS resources or system bandwidth (or component carrier) may be precoded with the predetermined precoder. Furthermore, the above examples as shown in FIGS. 12C and 12D may be combined with each other.

As another example of the first to seventh examples, the BS 20 may notify the UE 10 of information indicating time ranges (time location) in a time domain and/or frequency ranges (frequency location) in a frequency domain of the REs to which the IA is applied.

For example, the information indicating time ranges and/or frequency ranges of the REs may be notified as information for each symbol number unit or each subframe unit. Furthermore, the information indicating time ranges and/or frequency ranges of the REs may be notified as a combination of the information for each symbol number unit and the information for each subframe unit.

For example, the information indicating time ranges and/or frequency ranges of the REs may be notified as information for each subcarrier unit, each RB unit, or each sub-band unit.

For example, the information indicating time ranges and/or frequency ranges of the REs may be explicitly notified or be notified as information using grouping and/or periodicity.

As another example of the first example, when the UE receives the CSI-RSs from the BSs 20A and 20B (simultaneously), the UE 10 may assume that precoders applied to a plurality of (successive) RBs and a plurality of (successive) subframes from the BS 20B are identical.

For example, RB Information indicating the identical precoder applied to a plurality of (successive) RBs may be transmitted from the BS 20B to the UE 10 via higher layer (e.g., Radio Resource Control (RRC)) signaling and/or lower layer signaling. For example, the RB information includes information indicating the number of RBs to which the identical precoder is applied and/or the number of sub-bands to which the identical precoder is applied.

For example, subframe information indicating the identical precoder applied to a plurality of (successive) subframes may be transmitted from the BS 20B to the UE 10 via higher layer signaling and/or lower layer signaling. For example, the subframe information includes information indicating the number of subframes to which the identical precoder is applied. For example, the subframe information includes an offset value of a subframe number indicating timing to switch applied precoders.

As another example of the first to seventh examples, information indicating the REs to which the IA such as the REs precoded with the identical precoder may be transmitted with a RRC parameter such as a CSI-RS configuration and a CSI-RS subframe configuration.

As another example of the first to seventh examples, the UE 10 may trigger so as to apply the IA (like embodiments of the first to seventh examples) to the interfering resources. That is, the IA may be activated according to the trigger from the UE 10.

As another example of the first to seventh examples, on/off control of the IA (like embodiments of the first to seventh examples) and/or switching of IA-related information indicating the detailed IA may be notified to the UE 10. For example, the on/off control of the IA and/or the switching of the IA-related information may be notified as Downlink Control Information (DCI) or a combination of the higher layer signaling and the lower layer signaling.

### First Modified Example

In one or more embodiments of a first modified example of the present invention, the reference signals (RSs) or synchronization signals multiplexed on different time resources and frequency resources may be precoded with the identical precoder. The plurality of RSs precoded with the identical precoder, in terms of phases and amplitude, may be used for high accurate channel estimation. The RS may be the CSI-RS, the DM-RS, and a Cell-specific Reference Signal (CRS). The synchronized signal may be a Primary synchronization signal (PSS) and a Secondary synchronization signal (SSS). The RS and synchronization signal may be a newly defined signal.

FIG. 13 is a diagram showing the RSs multiplexed on the different time and frequency resources that is precoded with the identical precoder according to one or more embodiments of the first modified example of the present invention. As shown in FIG. 13, the six RSs multiplexed on the different time and frequency resources may be precoded with the identical precoder θ. For example, a plurality of RSs (six RSs) precoded with the identical precoder may be used for averaging of a plurality of samples of RSs and linear interpolation at the UE 10. As a result, the UE may perform the high accurate channel estimation based on a plurality of RSs (six RSs). Furthermore, the UE 10 may receive the RSs based on UE assumption that the UE 10 assumes that the six RSs multiplexed on the different time and frequency resources are precoded with the identical precoder θ.

### Second Modified Example

In one or more embodiments of a second modified example of the present invention, the RSs or synchronization signals multiplexed on different time resources and frequency resources may be precoded with the precoders having different successive phases (and/or amplitude). The successive phases may be successive in a time domain and/or a frequency domain.

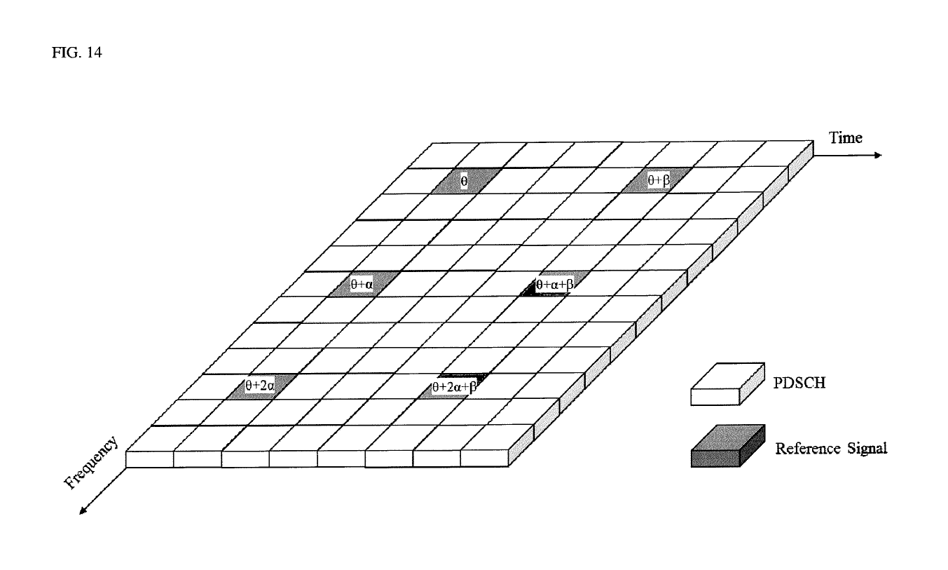

FIG. 14 is a diagram showing the RSs multiplexed on the different time and frequency resources that is precoded with the identical precoder according to one or more embodiments of the second modified example of the present invention. As shown in FIG. 14, the six RSs multiplexed on the different time and frequency resources may be precoded with the precoders having different successive phases such as precoders θ, θ+α, θ+2α, θ+θ, θ+α+β, θ+2α+β. For example, a plurality of RSs (six RSs) precoded with the precoders having different successive phases may be used for linear interpolation at the UE 10. As a result, the UE 10 may perform the high accurate channel estimation based on a plurality of RSs (six RSs), for example, by applying linear interpolation based channel estimation. Furthermore, the UE 10 may receive the RSs based on UE assumption that the UE 10 assumes that the six RSs multiplexed on the different time and frequency resources are precoded with the precoders having different successive phases and/or amplitude. Furthermore, when the successive precoders are secured in the entire system bandwidth and/or in time, it may not be required that the each of the phases differs per predetermined frequency range and/or predetermined time range.

In the above first and second modified examples, the BS 20 may transmit information used for the UE assumption (UE assumption information) to the UE 10. For example, the UE assumption information indicates:
the precoders (phase and/or amplitude) applied to the RSs can be independent of each other;
the precoders (phase and/or amplitude) applied to the RSs per certain frequency range and/or certain time range are identical;
the precoders (phase and/or amplitude) applied to the RSs may have the successive variation per certain frequency range and/or certain time range, e.g., linearly;
the precoders (phase and/or amplitude) applied to the RSs in the system bandwidth (or component carrier) are identical; and
the precoders (phase and/or amplitude) applied to the RSs has the different successive variation for each system bandwidth (or component carrier) or each set of a plurality of different subframes.

For example, the BS 20 may transmit the UE assumption information to the UE 10 via the higher layer signaling and/or the lower layer signaling. Then, the UE 10 may switch the UE assumption based on the received UE assumption information.

In the above first and second modified examples, the BS 20 may transmit information indicating REs precoded with the identical precoder or the precoders having the different successive phases to the UE 10.

For example, the information indicating frequency resources (e.g., the number of RBs) including the REs precoded with the identical precoder or the precoders having the different successive phases may be transmitted to the UE 10.

For example, the information indicating time resources (e.g., the number of subframes) including the REs precoded with the identical precoder or the precoders having the different successive phases may be transmitted to the UE 10. For example, the information indicating a location where the precoder is switched may be transmitted as a subframe offset to the UE 10.

For example, the UE assumption information and the above information indicating the precoded REs, the frequency and time resources including the precoded REs may be included in CSI-RS related information, CSI process related information, or DM-RS related information. For example, The CSI process related information may be CSI-Process, CSI-ProcessId, CSI-RS-Config, CSI-RS-ConfigNZP, CSI-RS-ConfigNZPId, CSI-RS-Config ZP, and CSI-RS-Config ZPId.

(Configuration of Base Station)

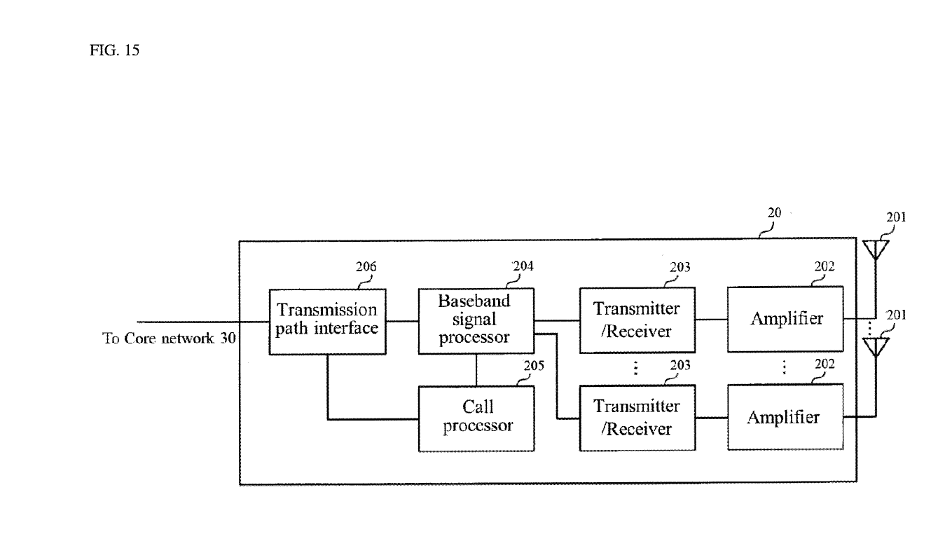

The BS 20 according to one or more embodiments of the present invention will be described below with reference to FIG. 15. FIG. 15 is a diagram illustrating a schematic configuration of the BS 20 according to one or more embodiments of the present invention. The BS 20 may include a plurality of antennas 201, amplifier 202, transceiver (transmitter/receiver) 203, a baseband signal processor 204, a call processor 205 and a transmission path interface 206.

User data that is transmitted on the DL from the BS 20 to the UE 20 is input from the core network 30, through the transmission path interface 206, into the baseband signal processor 204.

In the baseband signal processor 204, signals are subjected to Packet Data Convergence Protocol (PDCP) layer processing, Radio Link Control (RLC) layer transmission processing such as division and coupling of user data and RLC retransmission control transmission processing, Medium Access Control (MAC) retransmission control, including, for example, HARQ transmission processing, scheduling, transport format selection, channel coding, inverse fast Fourier transform (IFFT) processing, and precoding processing. Then, the resultant signals are transferred to each transceiver 203. As for signals of the DL control channel, transmission processing is performed, including channel coding and inverse fast Fourier transform, and the resultant signals are transmitted to each transceiver 203.

The baseband signal processor 204 notifies each UE 10 of control information (system information) for communication in the cell by higher layer signaling (e.g., RRC signaling and broadcast channel). Information for communication in the cell includes, for example, UL or DL system bandwidth.

In each transceiver 203, baseband signals that are precoded per antenna and output from the baseband signal processor 204 are subjected to frequency conversion processing into a radio frequency band. The amplifier 202 amplifies the radio frequency signals having been subjected to frequency conversion, and the resultant signals are transmitted from the antennas 201.

As for data to be transmitted on the UL from the UE 10 to the BS 20, radio frequency signals are received in each antennas 201, amplified in the amplifier 202, subjected to frequency conversion and converted into baseband signals in the transceiver 203, and are input to the baseband signal processor 204.

The baseband signal processor 204 performs FFT processing, IDFT processing, error correction decoding, MAC retransmission control reception processing, and RLC layer and PDCP layer reception processing on the user data included in the received baseband signals. Then, the resultant signals are transferred to the core network 30 through the transmission path interface 206. The call processor 205 performs call processing such as setting up and releasing a communication channel, manages the state of the BS 20, and manages the radio resources.

(Configuration of User Equipment)

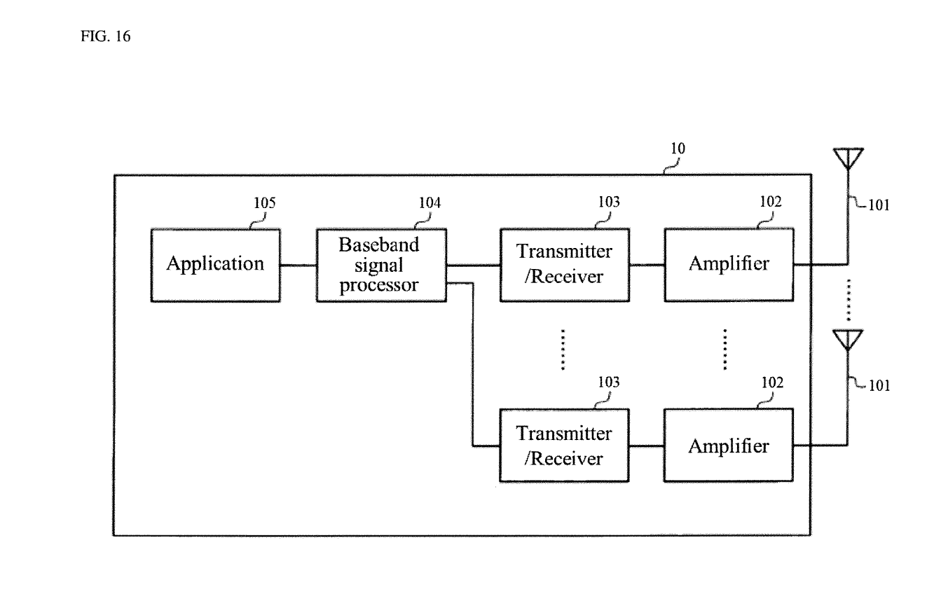

The UE 10 according to one or more embodiments of the present invention will be described below with reference to FIG. 16. FIG. 16 is a schematic configuration of the UE 10 according to one or more embodiments of the present invention. The UE 10 has a plurality of UE antennas 101, amplifiers 102, transceiver (transmitter/receiver) 103, a baseband signal processor 104, and an application 105.

As for DL, radio frequency signals received in the UE antennas 101 are amplified in the respective amplifiers 102, and subjected to frequency conversion into baseband signals in the transmission/reception sections 103. These baseband signals are subjected to reception processing such as FFT processing, error correction decoding and retransmission control and so on, in the baseband signal processor 104. The DL user data is transferred to the application 105. The application 105 performs processing related to higher layers above the physical layer and the MAC layer. In the downlink data, broadcast information is also transferred to the application 105.

On the other hand, UL user data is input from the application 105 to the baseband signal processor 104. In the baseband signal processor 104, retransmission control (Hybrid ARQ) transmission processing, channel coding, precoding, DFT processing, IFFT processing and so on are performed, and the resultant signals are transferred to each transceiver 103. In the transceiver 103, the baseband signals output from the baseband signal processor 104 are converted into a radio frequency band. After that, the frequency-converted radio frequency signals are amplified in the amplifier 102, and then, transmitted from the antenna 101.

In one or more embodiments of the present invention, an example will be described that the CSI-RSs between adjacent cells collides with each other (the desired signal and the interfering signal are the CSI-RSs), but the interfering signal may be the PDSCH, other physical channels, or other signals.

Although the present disclosure mainly described systems applying Rx power based beam selection, the present invention is not limited thereto. One or more embodiments of the present invention may also apply to other beam management schemes or CSI acquisition schemes that is affected by interference.

Although the present disclosure mainly described examples of inter-cell interference and decreasing the inter-cell interference fluctuations, the present invention is not limited thereto. One or more embodiments of the present invention may also apply to inter-user interference in multi-user MIMO.

Although the present disclosure mainly described examples of the interference alignment applied to the beamformed CSI-RSs, the present invention is not limited thereto. In one or more embodiments of the present invention, the CSI-RSs may be not beamformed for applying the interference alignment. Furthermore, in the LTE-A/NR standards, whether the CSI-RSs are beamformed may not be explicitly disclosed.

The above examples and modified examples may be used for desired beam selection or undesired beam selection. For example, the beam selection may be applied to decrease inter-cell interference and inter-user interference.

Although the present disclosure mainly described examples of downlink transmission, the present invention is not limited thereto. One or more embodiments of the present invention may also apply to uplink transmission.

Although the present disclosure mainly described examples of a channel and signaling scheme based on LTE/LTE-A, the present invention is not limited thereto. One or more embodiments of the present invention may apply to another channel and signaling scheme having the same functions as LTE/LTE-A, New Radio (NR), and a newly defined channel and signaling scheme.

Although the present disclosure mainly described examples of the channel estimation based on the CSI-RS and the CSI feedback scheme, the present invention is not limited thereto. One or more embodiments of the present invention may also apply to other reference signals, synchronization signals, and physical signals and channels (e.g., synchronization signal, beam RS, cell-specific RS, sounding reference signal (SRS), uplink/downlink DMRS, and Physical Random Access Channel (PRACH)) rather than the CSI-RS.

In one or more embodiments of the present invention, the RB and the subcarrier may be replaced with each other. Similarly, in one or more embodiments of the present invention, the subframe and the symbol may be replaced with each other.

The above examples and modified examples may be combined with each other, and various features of these examples can be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### EXPLANATION OF REFERENCES

1 Wireless communication system
10 User equipment (UE)
101 Antenna
102 Amplifier
103 Transceiver (transmitter/receiver)
104 Baseband signal processor
105 Application
20 Base station (BS)
201 Antenna
202 Amplifier
203 Transceiver (transmitter/receiver)
204 Baseband signal processor
205 Call processor
206 Transmission path interface cm What is claimed is:

1. A method for wireless communication, the method comprising:
receiving, with a user equipment (UE), first information indicating predetermined resources of first resources used for transmission of first signals and second information indicating interference alignment applied to the predetermined resources, from a first base station (BS); and
receiving, with the UE,
the first signals using the first information and the second information from the first BS; and
second signals transmitted using second resources,
wherein the predetermined resources cause interference with the second resources at the UE, and
wherein an interference level of the predetermined resources is aligned.

2. The method according to claim 1, wherein transmission power of the predetermined resources is identical.

3. The method according to claim 2, wherein the transmission power of the predetermined resources differs from transmission power of resources other than the predetermined resources of the first resources.

4. The method according to claim 2, wherein the second information indicates a value of the transmission power.

5. The method according to claim 1, wherein the predetermined resources are muted.

6. The method according to claim 1, transmission power of the predetermined resources is lower than transmission power of resources other than the predetermined resources of the first resources.

7. The method according to claim 1, the predetermined resources are precoded with an identical precoder.

8. The method according to claim 7, wherein the identical precoder differs from precoders applied to resources other than the predetermined resources of the first resources.

9. The method according to claim 7, wherein the second information indicates the identical precoder.

10. The method according to claim 1, wherein precoding for the predetermined resources is disabled.

11. The method according to claim 1, wherein code division multiplexing (CDM) is applied to the predetermined resources.

12. The method according to claim 11, wherein the second information indicates the CDM applied to the predetermined resources.

13. The method according to claim 1, wherein the predetermined resources are scrambled.

14. The method according to claim 11, wherein the second information indicates that the predetermined resources are scrambled.

15. The method according to claim 1, further comprising:
receiving, with the UE, a demodulation reference signal (DM-RS) for decoding of the predetermined resources from the first BS.

16. The method according to claim 1, further comprising:
transmitting, from a second BS to the UE, the second signals using the second resources.

17. The method according to claim 2, wherein the transmission power of the predetermined resources in a time domain or a frequency is identical.

18. The method according to claim 7, wherein the identical precoder s applied to the predetermined resources in a time domain or a frequency.

19. A user equipment (UE) comprising:
a receiver that receives, from a base station (BS):
first information indicating predetermined resources of first resources used for transmission of first signals and second information indicating interference alignment applied to the predetermined resources;
the first signals using the first information and the second information; and
second signals transmitted using second resources,
wherein the predetermined resources cause interference with the second resources at the UE, and
wherein an interference level of the predetermined resources is aligned.

20. A base station (BS) comprising:
a processor that causes an interference level of predetermined resources of first resources to be aligned; and
a transmitter that transmits first information indicating the predetermined resources and second information indicating that the interference level of the predetermined resources is aligned,
wherein the transmitter transmits first signals using the first resources to a user equipment (UE),
wherein the predetermined resources cause interference with second resources used for transmission of second signals at the UE.
